(19) United States
(12) Patent Application Publication
(10) Pub. No.: US 2008/0082429 A1
(43) Pub. Date: Apr. 3, 2008

(54) Systems and methods for automatically resolving bin errors

(76) Inventors: Andrew C. Stein, Morton, IL (US); Tammi L. Duncan, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/529,485

(22) Filed: Sep. 29, 2006

(51) Int. Cl. G06Q 10/00

(52) U.S. Cl. 705/28

(57) ABSTRACT

Systems and methods are provided for automatically resolving bin errors. In one implementation, a system is provided that includes a difference analyzer that stores a record of a discrepancy involving stock. The system also includes an inventory server comprising a database of inventory records. The inventory server identifies a negative bin quantity or a no bin situation due to the discrepancy. When the inventory server identifies a negative bin quantity situation, the inventory server determines whether the negative bin quantity falls within a tolerance value. When the inventory server identifies a no bin situation, the inventory server determines whether a bin exists for a product number and a country of origin associated with the stock identified in the discrepancy.

### TECHNICAL FIELD

The present disclosure relates generally to automatically resolving bin errors, and more particularly, to systems and methods for identifying negative bin quantities or no bin situations and automatically determining whether to update bin quantities in an inventory system.

### BACKGROUND

In a warehouse, storage areas for storing stock may include rows of shelves that include a large number of storage bins. The storage bins are typically labeled so that workers can locate stock in the warehouse. During warehouse operations, workers may need to locate stock for a variety of reasons. For example, workers may need to locate stock in order to ship the stock outside of the warehouse to satisfy an order placed by a customer for a certain quantity of a particular stock. Workers may also need to ship stock outside of the warehouse due to an inter-facility order (i.e., a transfer of the stock from one warehouse to another). Alternatively, workers may need to ship stock intra-facility to reorganize stock in the warehouse (i.e., moving stock from one bin to another in the same warehouse).

When stock is shipped outside of the warehouse or moved to a new location, a worker typically updates a computerized inventory system in order to record an updated bin quantity of the stock. Such a system may maintain location information describing where stock is located in the warehouse. For example, the worker may use a scanner to scan a bar code or radio frequency identification (RFID) tag on a bin to record movement of the stock from the bin. A database in the computerized inventory system is then updated to reflect a new quantity for the bin.

Discrepancies between actual inventory levels (i.e., the amount of stock physically located in a particular bin) and bin quantities in the computerized inventory system may occur for a variety of reasons. In some situations, an inventory system may reflect a negative bin quantity for a particular stock (i.e., a negative bin quantity situation). Since it is not possible to have a negative amount of the stock, such negative stock situations may trigger an inventory recount situation, even for just one negative quantity. Furthermore, in other situations, an inventory system may reflect a positive quantity for a particular stock, but a bin may no longer exist in the warehouse for that particular stock (i.e., a no bin situation). This sort of situation might occur in a large warehouse because bins that are no longer being used are often quickly reassigned to a different stock. Resolving these kinds of situations is time consuming and an inefficient use of resources since a worker will have to recount a bin and/or search a warehouse for stock that is no longer assigned to a bin.

One method of managing inventory is described in U.S. Publication No. 2005/0246246 A1 (the '246 application) to Nishimoto et al., which published on Nov. 3, 2005. The '246 application describes a tool that provides feedback regarding inventory levels. Although the system of the '246 application may compare a target inventory level against an actual inventory level, the system does not identify and correct negative bin quantities or no bin situations for stock.

The disclosed system and methods are directed to overcoming one or more of the problems set forth above.

### SUMMARY OF THE INVENTION

In one aspect, the present disclosure is directed to a system for automatically resolving bin errors. The system may include a difference analyzer that stores a record of a discrepancy involving stock. The system may also include an inventory server comprising a database of inventory records. The inventory server may identify a negative bin quantity or a no bin situation due to the discrepancy. When the inventory server identifies a negative bin quantity situation, the inventory server may determine whether the negative bin quantity falls within a tolerance value. When the inventory server identifies a no bin situation, the inventory server may determine whether a bin exists for a product number and a country of origin associated with the stock identified in the discrepancy.

In another aspect, the present disclosure is directed to a method for automatically resolving bin errors. The method may include receiving a discrepancy involving stock. A record of the discrepancy may be stored in a difference analyzer. The method may further include identifying a negative bin quantity or a no bin situation due to the discrepancy. When a negative bin quantity is identified, the method may determine whether the negative bin quantity falls within a tolerance value. When a no bin situation is identified, the method may determine whether a bin exists for a product number and a country of origin matching the stock identified in the discrepancy.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an exemplary warehouse environment, consistent with a disclosed embodiment;

FIG. 2 is an exemplary system for automatically resolving bin errors, consistent with a disclosed embodiment;

FIG. 3 is an exemplary data table of exemplary inventory records, consistent with a disclosed embodiment;

FIG. 4 is an exemplary data table of exemplary records for storing stock discrepancies, consistent with a disclosed embodiment;

FIG. 5 is an exemplary software architecture for automatically resolving bin errors in an inventory server, consistent with a disclosed embodiment;

FIG. 6 is a flow diagram of an exemplary method for resolving a negative bin quantity situation, consistent with a disclosed embodiment; and

FIG. 7 is a flow diagram of an exemplary method for resolving a no bin situation, consistent with a disclosed embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

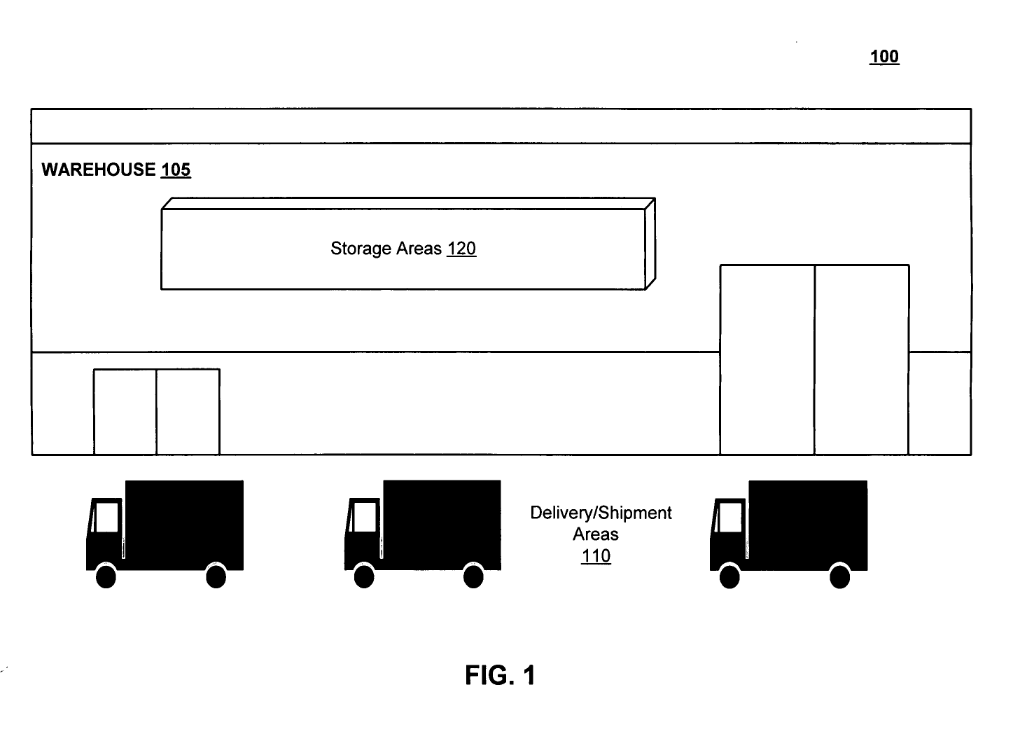

FIG. 1 is an exemplary warehouse environment 100, consistent with a disclosed embodiment. Warehouse environment 100 includes warehouse 105, which handles and stores stock. In one embodiment, warehouse 105 may function as the main warehouse facility of a supplier or merchant of goods or services. In other embodiments, warehouse 105 may be one of several warehouse facilities that are regionally located and/or part of a distribution network.

As used herein, the term “stock” refers to any quantity of an item in a warehouse or other facility. For example, stock may comprise any quantity or number of parts for manufacturing or providing a finished product, or any quantity or number of parts that are used for providing services. Stock may also comprise commercial products or any other item. By way of further example, in the context of a warehouse environment for a machinery supplier, stock may comprise machinery parts, engine parts, heavy equipment parts and the like.

Warehouse 105 may include a number of areas. For example, warehouse 105 may include one or more delivery and/or shipment areas 110 for receiving and shipping stock. Delivery/shipment areas 110 may include dock areas where shipping vehicles (e.g., shipping trucks, vans, etc.) are received. These dock areas may be used for the unloading or loading of pallets of stock. In addition, one or more storage areas 120 may store stock inside of warehouse 105. Storage areas 120 may include a large number of storage bins that are arranged, for example, in rows of shelves (not shown). Additionally, or alternatively, other types of storage elements (such as containers, buckets, barrels and the like) may be used in storage areas 120.

Conventional techniques may be used for organizing and storing stock in storage areas 120. For example, bins located in storage areas 120 may be labeled for ease of identification. Labeling may be achieved through the use of any type of indicia or label, such as bar code labels or RFIDs. In addition to labeling the bins, each storage area (e.g., each row of shelf space, etc.) in storage areas 120 may be labeled or otherwise marked. Using the relevant row and bin information, warehouse workers may locate stock in the warehouse.

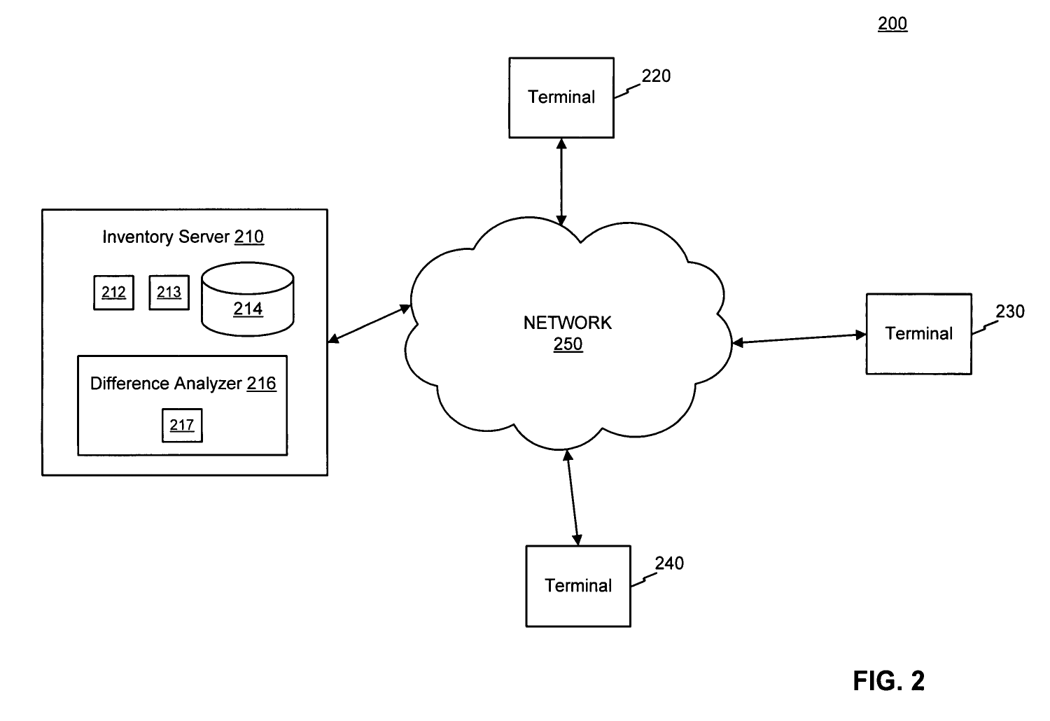

To control the movement of stock in warehouse 105, warehouse workers may use a computerized inventory system (not shown in FIG. 1). Such a system may maintain location information (e.g., row and bin information) for all stock in the warehouse. The system may also maintain and issue orders to instruct warehouse workers to move stock in the warehouse and to pack stock for shipment outside of the warehouse. To accomplish the above and other functionality, the system may include software-enabled logic and a database, as is described in further detail with regard to FIG. 2.

FIG. 2 is an exemplary system 200 for automatically resolving bin errors, consistent with a disclosed embodiment. As shown in system 200, inventory server 210, and terminals 220, 230, and 240 are connected to a network 250. One of skill in the art will appreciate that although three terminals are depicted in FIG. 2, any number of terminals may be provided. Further, one of ordinary skill in the art will recognize that functions provided by one or more components of system 200 may be combined.

Network 250 provides communications between the various entities in system 200, such as inventory server 210 and terminals 220-240. In addition, inventory server 210 and terminals 220-240 may access legacy systems (not shown) via network 250, or may directly access legacy systems and/or databases. Network 250 may be a shared, public, or private network, may encompass a wide area or local area, and may be implemented through any suitable combination of wired and/or wireless communication networks. Furthermore, network 250 may comprise a local area network (LAN), a wide area network (WAN), an intranet, or the Internet.

Inventory server 210 may comprise a general purpose computer (e.g., a personal computer, network computer, server, or mainframe computer) having a processor 212 that may be selectively activated or reconfigured by a computer program and a data storage 213 for storing program instructions. Inventory server 210 may also be implemented in a distributed network. Alternatively, inventory server 210 may be specially constructed for carrying-out methods consistent with a particular embodiment. Accordingly, inventory server 210 may include software-based logic (not shown) for tracking the day-to-day movement of stock in and out the warehouse.

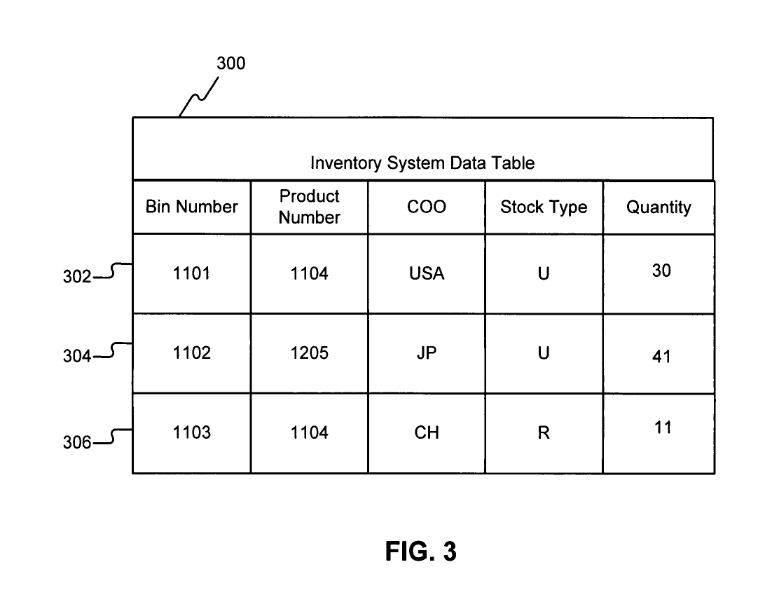

Furthermore, inventory server 210 may include a processor 212 and a database 214 for storing data records for stock in warehouse 105. For example, data records stored in database 214 may each specify a bin number, product number, country of origin (COO), stock type, and quantity of the stock in the bin. Bin numbers and product numbers may include numerical digits, letters, or a combination of alphanumeric characters. The “stock type” may indicate whether the stock is or is not currently available for sale. For example, the “stock type” may be unrestricted (i.e., the stock is currently available for sale) or restricted (i.e., the stock is not currently for sale). An exemplary data structure including exemplary records that may be stored in database 214 of inventory server 210 is described in more detail in connection with FIG. 3.

In one embodiment, in order to update database 214 of inventory server 210, an inventory count document is created for a particular stock and all bins are counted for that stock. Then, updated quantities of each bin are entered in inventory server 210. Updates may be processed by workers at terminals 220-240 and/or by using handheld devices (not shown), such as scanners, to scan a bar code or radio frequency identification (RFID) tag on the bin to record movement of the stock from the bin and/or to indicate a quantity of stock counted for a particular bin.

Furthermore, inventory server 210 may provide functionality for resolving negative bin quantities or non bin situations. For example, software modules stored in data storage 213 may generate program instructions to evaluate a discrepancy and automatically determine whether to update bin quantities in inventory server 210.

Inventory server 210 may also include difference analyzer 216. Difference analyzer 216 may include a data storage 217. Data storage 217 may store discrepancy data for a negative bin quantity or a no bin situation. Furthermore, in some embodiments, data storage 217 may store program instructions to evaluate the stored discrepancy data and automatically determine whether to update bin quantities in inventory server 210.

As shown in FIG. 2, difference analyzer 216 is included in inventory server 210. However, one of ordinary skill in the art will recognize that the components and functionality of difference analyzer 216 may be provided by a separate component in system 200. For example, difference analyzer 216 may be implemented as a computing-based platform (e.g., a workstation, a computer, a laptop, a server, a network computer and the like) that is available via network 250.

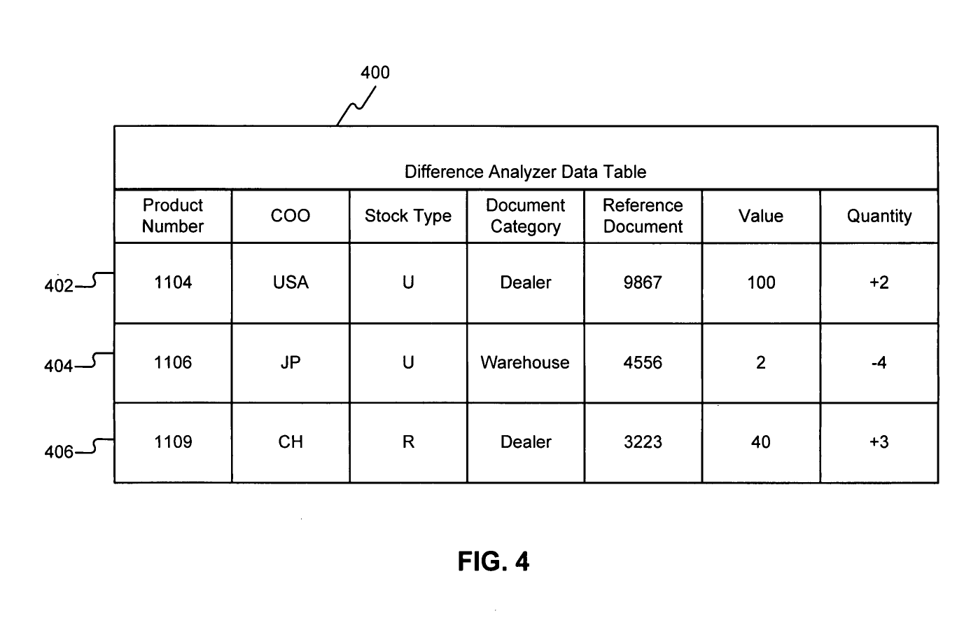

When a discrepancy is identified by, for example, inventory server 210, difference analyzer 216 may store a data record for one or more items of stock identified in the discrepancy data. As an example, a dealer may submit a claim to a distributor indicating that the dealer is missing a quantity of a particular item. A record including the indicated quantity of the item may be posted to difference analyzer 216 at the direction of inventory system 210 and/or via manual entry. If, for example, the dealer ordered ten of a particular part, but only received nine parts, a record including a credit of one part (i.e., a +1 quantity for that item) is stored in, for example, data storage 217 of difference analyzer 216. An exemplary data structure including exemplary records for storing discrepancies is described in more detail in connection with FIG. 4.

Furthermore, inventory server 210 may determine whether a negative quantity is on hand for a particular stock that may be the subject of a claim. For example, difference analyzer 216 may store a claim having a negative quantity as a data record in data storage 217 until the discrepancy is resolved. Inventory server 210 may automatically resolve the negative quantity situation, as is described in further detail below. As yet another example, if a bin does not exist for a particular stock that may be the subject of a claim, then inventory server 210 may resolve the no bin situation, as is also described in further detail below.

Terminals 220-240 may be any type of device for communicating with inventory server 210 and/or difference analyzer 216 over network 250. For example, terminals 220-240 may be personal computers, handheld devices, or any other appropriate computing platform or device capable of exchanging data with network 250, inventory server 210, and/or difference analyzer 216. Terminals 220-240 may each include a processor and a data storage. Further, terminals 220-240 may execute program modules that provide one or more graphical user interfaces (GUIs) for interacting with network resources to transmit and/or receive data from inventory server 210 and/or difference analyzer 216.

Users may access data provided by inventory server 210 via network 250 through a web browser or software application running on, for example, any one of terminals 220-240. For example, a web portal may include options for allowing a user to log onto a secure site provided by inventory server 210 by supplying credentials, such as a username and a password. Once logged onto the site, the web portal may display a series of screens prompting the user to make various selections for reviewing inventory and updating inventory in inventory server 210. Since some disclosed embodiments may be implemented using an HTTPS (hypertext transfer protocol secure) environment, data transfer over a network, such as the Internet, may be done in a secure fashion.

In some embodiments, a web interface generated by inventory server 210 that is displayed to users of terminals 220-240 may provide various options. For example, a user may use terminal 220 to retrieve data from inventory server 210 including a location of a particular type of stock in warehouse 105. Further, a user may generate a report at terminal 220, which indicates the location of stock in warehouse 105.

One or more of the components illustrated in FIG. 2 may be physically located at warehouse 105 or located remotely from the warehouse at, for example, a head office or management facility. Therefore, the location of inventory server 210 and other components are not critical for implementing the systems and methods disclosed herein.

FIG. 3 is an exemplary data table 300 of exemplary inventory records 302-306, consistent with a disclosed embodiment. In one embodiment, data table 300 may be stored in database 214 of inventory server 210. One of ordinary skill in the art will recognize that in other embodiments, data table 300 may be stored in other locations, such terminals 220-240, for example.

As shown in FIG. 3, each row of data table 300 represents a particular record. Furthermore, each of records 302-306 represents a particular bin and its associated stock. In particular, each of records 302-306 include a bin number, product number, country of origin (COO), stock type, and quantity of stock in the bin. Bin numbers and product numbers may include numerical digits, letters, or a combination of alphanumeric characters. The “stock type” may indicate whether the stock is or is not currently available for sale. For example, the “stock type” may be unrestricted (i.e., the stock is currently available for sale) or restricted (i.e., the stock is not currently for sale). For example, data table 300 indicates that thirty parts having product number 1104 and that originated from the United States are stored in bin 1101 and eleven parts having the same product number and that originated from China are stored in bin 1103. One of ordinary skill in the art will recognize that data table 300 is merely exemplary and may only describe a portion of stock stored in database 214.

FIG. 4 is an exemplary data table 400 of exemplary records 402-406 for storing stock discrepancies, consistent with a disclosed embodiment. In one embodiment, data table 400 may be stored in data storage 217 of difference analyzer 216. One of ordinary skill in the art will recognize that in other embodiments, data table 400 may be stored in inventory server 210 or terminals 220-240, for example.

As shown in FIG. 4, each row of data table 400 represents a particular record. Furthermore, each of records 402-406 represents a discrepancy that may be associated with a particular claim that has been stored and/or received by difference analyzer 216. Each of records 402-406 include a product number, country of origin (COO), stock type, document category, reference document, value, and a quantity of stock. As discussed above, product numbers may include numerical digits, letters, or a combination of alphanumeric characters and the “stock type” may be unrestricted (i.e., the stock is currently available for sale) or restricted (i.e., the stock is not currently for sale). The “document category” may indicate whether the discrepancy is due to a dealer claim, an inter-facility discrepancy, or a warehouse task discrepancy. The “reference document” may indicate a claim number or receipt number for purposes of tracking the claim.

For example, as shown in FIG. 4, record 402 indicates a product number of 1104, the United States is the country of origin, the stock type is unrestricted, the document category indicates it is a dealer claim, the reference document is 9867, the value is $100.00 per quantity, and the quantity is +2. The quantity of +2 includes that the dealer was missing two of a particular item. Thus, it is expected that the warehouse includes two additional pieces of the item that are not otherwise accounted for in inventory server 210.

As another example, record 404 indicates a product number of 1106, Japan is the country of origin, the stock type is unrestricted, the document category indicates it is a warehouse claim, the reference document is 4556, the value is $2.00 per quantity, and the quantity is −4. The quantity of −4 indicates that the warehouse is missing four the particular item that may not be otherwise accounted for in inventory server 210. As yet another example; record 406 indicates a product number of 1109, China is the country of origin, the stock type is restricted, the document category indicates it is a dealer claim, the reference document is 3223, the value is $40.00 per quantity, and the quantity is +3. The quantity of +3 indicates that the dealer was missing three of the particular item.

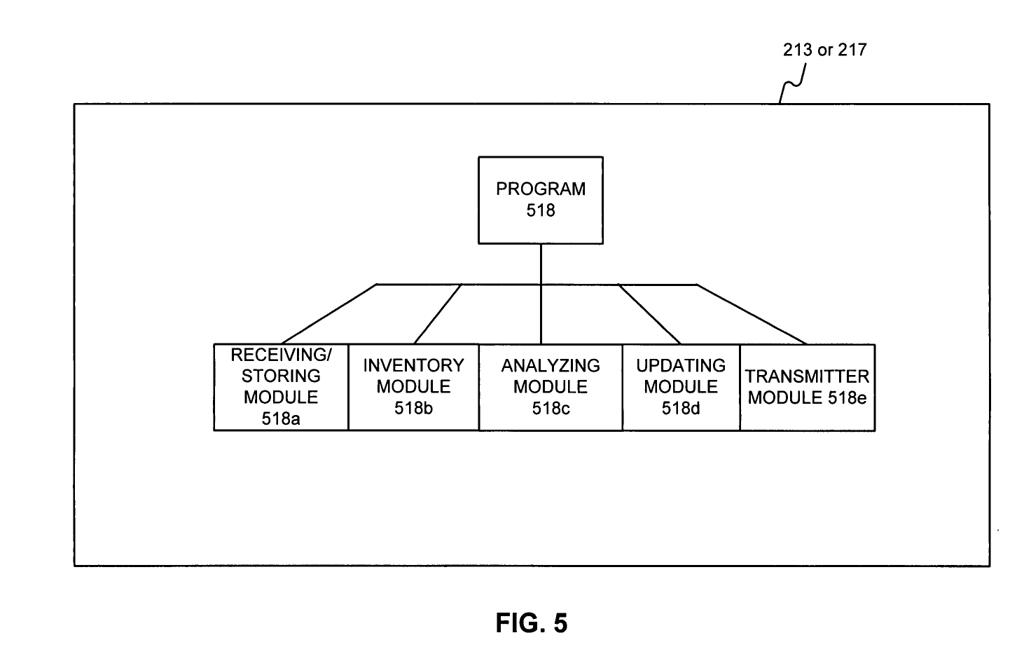

FIG. 5 is an exemplary software architecture for automatically resolving bin errors in inventory server 210, consistent with a disclosed embodiment. The software architecture may stored in data storage 213 of inventory server 210, as shown in FIG. 2, for example. In other embodiments, the software architecture may be stored in data storage 217 of difference analyzer 216.

In one embodiment, data storage 213 or 217 may store instructions of program 518, which when executed, perform a process to automatically resolve a negative bin quantity or no bin situation. To do so, program 518 may include instructions in the form of one or more software modules 518a-518e. Software modules 518a-518e may be written using any known programming language, such as C++, XML, etc., and may include a receiving and storing module 518a, a inventory module 518b, an analyzer module 518c, an updating module 518d, and a transmitter module 518e.

Receiving and storing module 518a may receive and store a discrepancy indicating a negative bin quantity or a no bin situation. For example, inventory server 210 may receive a claim from one of terminals 220-240. The claim may be a dealer claim, a inter-facility claim, or a warehouse claim. The claim may be stored by difference analyzer 216 for further processing. Further, the claim may include data stored in a data structure such as a record, as shown in FIG. 3. For example, the record may include a product number, country of origin (COO), stock type, document category, reference document, value, and a quantity of stock.

Inventory module 518b may verify inventory levels of the stock identified in a received discrepancy by interfacing with inventory server 210. For example, in a negative bin quantity situation, inventory module 518b may examine data records stored by inventory server 210 in order to identify all inventoried stock having the product number associated with a particular claim. For example, as shown in FIG. 3, although bins 1101 and 1103 have different countries of origins, the bins store stock having the same product number. Inventory module 518b will aggregate all quantities of a particular stock to determine a total for a particular product number. Aggregation by inventory module 518b is performed regardless of country of origin, stock type, or document category. Accordingly, even though data table 300 indicates that thirty parts having product number 1104 and that originated from the United States are stored in bin 1101 and eleven parts having the same product number and that originated from China are stored in bin 1103, inventory module 518b will sum these quantities to arrive at a total of forty-one parts.

Inventory module 518b may also determine whether a bin exists in warehouse 105 for a particular stock. For example, inventory module 518b may examine inventory system data table 300 to determine whether a bin number is assigned to the product number in question. Inventory module 518b may do so by examining all data records stored in data table 300 for a particular product number. If the product number is found and is assigned to a bin number, then a no bin situation does not exist. However, if inventory module 518b does not locate a bin number that is assigned to the product number in data table 300, then a no bin situation has been encountered.

Analyzing module 518c may determine how to resolve a negative bin quantity situation or a no bin situation. For example, in a negative bin quantity situation, if a quantity of a claim is negative, and a total quantity of that stock, including the quantity of the claim is negative, then analyzing module 518c may compute a tolerance value. The tolerance value may based on a formula that takes into account a value of the stock, a percentage of average inventory for the stock over a specified period of time, or a combination of the value of the stock and the percentage of average inventory for the stock.

For example, if a value of the stock that is the subject of the claim is less than the tolerance value, then analyzing module 518c may automatically determine that the bin quantity for that stock should not be updated. In such a situation, the quantity is posted to a database of a financial department. As another example, when bin quantities for a particular stock reflect a negative quantity, if the absolute value of that negative quantity (i.e., treating the negative quantity as a positive quantity) is less than a predetermined percentage of average inventory, then analyzing module 518c may automatically determine that a count should not be created for that product and the negative quantity is automatically posted to a database of a financial department. In yet another example, when bin quantities for a particular stock reflect a negative quantity, if a value of that stock is less than a predetermined cost and the absolute value of that negative quantity is less than a predetermined percentage of average inventory, then analyzing module 518c may automatically determine that a count should not be created for that product and the negative quantity is automatically posted to a database of a financial department. Accordingly, when the discrepancy falls within the tolerance value, analyzing module 518c will determine that the quantity and/or value is not significant enough to spend additional resources. Accordingly, the negative quantity is automatically posted to a financial department.

However, in a negative bin quantity situation, when the negative quantity or the value of the stock does not fall with the tolerance value, then analyzing module 518c will determine that an inventory count document should be generated in order to require a clerk to perform a manual count. That is, the discrepancy is considered large enough in value and/or quantity in order to warrant a manual count of the product.

For example, a dealer may specify in a claim that he received an extra engine, worth $15,000. Inventory module 518b may determine that there are only two engines. Accordingly, a comparison between the value of the engine and/or the percentage of average inventory that one engine constitutes may indicate that the value and/or percentage of average inventory is greater than the tolerance value. Analyzing module 518c may determine that the discrepancy is significant and a count document is created for that product. Thus, based on the tolerance value, a decision is automatically made that the discrepancy warrants further resources and time.

In a no bin situation, analyzing module 518c may determine whether the quantity and/or value of a particular stock that is included in a claim and that is for a stock that does not have an existing bin in a warehouse for that country of origin and product number combination is significant in relation to a tolerance value. If the quantity and/or value is not significant in relation to a tolerance value, then analyzing module 518c may determine that the discrepancy residing in difference analyzer 216 should be automatically posted to a financial department. That is, it is not a significant value and/or quantity justifying further expenditure of time and resources. If the quantity and/or value is significant, then analyzing module 518c will determine whether there are any other bins for that product for a different county of origin. If there are additional bins for that product, then analyzing module 518c will determine that an inventory count document should be generated so that a clerk can manually count the bin. If there are no additional bins for that product, then analyzing module 518c will determine that a report should be created that can be used to investigate the discrepancy since a bin does not exist anymore.

Updating module 518d may cause inventory server 210 to update a quantity of stock in database 214 and/or post the discrepancy to a financial department. For example, in a negative bin quantity situation, once it has been determined by analyzing module 518c that a value and/or quantity of a particular stock is below a threshold value, the record of the discrepancy stored in difference analyzer 216 may be posted to a database of a financial department.

Transmitter module 518e may transmit notifications in certain situations. In particular, transmitter module 518e may generate and format an appropriate message (such as an e-mail, voice mail, text message, etc.) and transmit that message to another system or one of terminals 220-240 for processing by a clerk. For example, a clerk may be required to review a claim and may need to perform a recount and/or investigate the claim. In other circumstances, transmitter module 518e may generate, format, and transmit an appropriate message to another department, such as a financial department.

Although program modules 518a-518e have been described above as being separate modules, one of ordinary skill in the art will recognize that functionalities provided by one or more modules may be combined. Furthermore, one of ordinary skill in the art will recognize that program 518 may reside in inventory server 210, difference analyzer 216, or in any one of terminals 220-240.

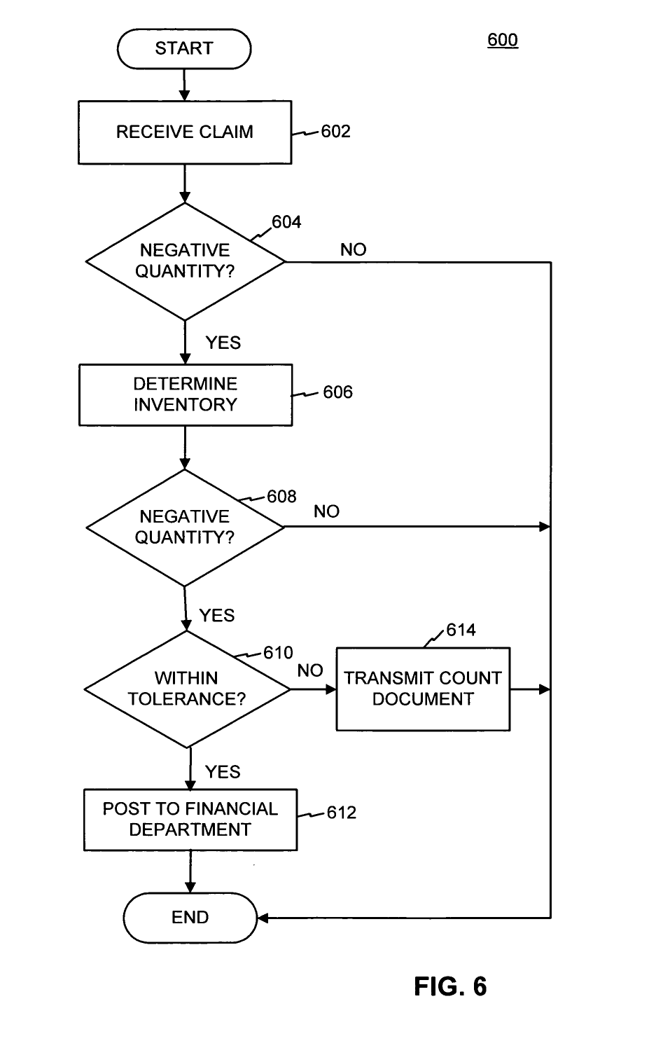

Referring now to FIG. 6, a flow diagram 600 is provided of an exemplary method for resolving a negative bin quantity situation, consistent with a disclosed embodiment. For example, the method may implement processes according to program modules 518a-518e.

At the start of the process, in step 602, receiving and storing module 518a of difference analyzer 216 may receive and store a claim. The claim may be a dealer claim, inter-facility claim, or a warehouse claim that was received by inventory server 210 and/or discrepancy server 216. For example, receiving and storing module 518a may store a claim that was received from one of terminals 220-240 in difference analyzer 216, for example. The process proceeds to step 604.

In step 604, analyzing module 518c may determine whether an aggregate quantity of the discrepancies stored in difference analyzer 216 for that product are negative based on a product and country of origin combination. If the aggregate quantity is not negative, then there is no further processing. However, if the aggregate quantity is negative, then the process proceeds to step 606.

In step 606, inventory server 210 verifies inventory levels of the identified stock. For example, inventory module 518b may verify inventory levels of the stock by interfacing with inventory server 210. Furthermore, inventory module 518b may examine data stored by inventory server 210 to identify all inventoried stock having a product number associated with a particular claim. In this step, inventory module 518b will aggregate all quantities of a particular stock to determine a total. Accordingly, aggregation by inventory module 518b is performed regardless of country of origin, stock type, or document category. The process proceeds to step 608.

In step 608, analyzing module 518c determines whether the sum of the quantity of all stock aggregated in step 606 and the quantity of the stock indicated in the claim is negative. Accordingly, the sum determined that was previously determined in step 604 is aggregated with the quantity of stock specified in the claim currently being processed. If the total sum is still negative, then there is a negative bin situation and the process proceeds to step 610. If the total is positive, then the process ends.

In step 610, to resolve the situation where the total sum of the stock on-hand is negative, analyzing module 518c will evaluate whether a value and/or quantity of the negative stock falls within a tolerance value. If the value and/or quantity does not fall within the tolerance value, then the process proceeds to step 614. If the value and/or quantity falls within the tolerance value, then the process proceeds to step 612.

In step 612, updating module 518d will automatically post the discrepancy residing in difference analyzer 216 to a financial department and will not change the bin quantities for the stock. That is, since the value and/or quantity in the claim was considered insignificant, it is determined that resolving the negative bin quantity is not worth an expenditure of additional time and resources. The process then ends.

In step 614, since the value and/or quantity in the claim is considered significant, transmitter module 518e automatically creates and transmits an inventory count document to a clerk in order to require a manual recount. For example, transmitter module 518e may generate and format an appropriate message (such as an e-mail, voice mail, text message, etc.) and transmit that message to another system or one of terminals 220-240 for processing by a clerk. The process then ends.

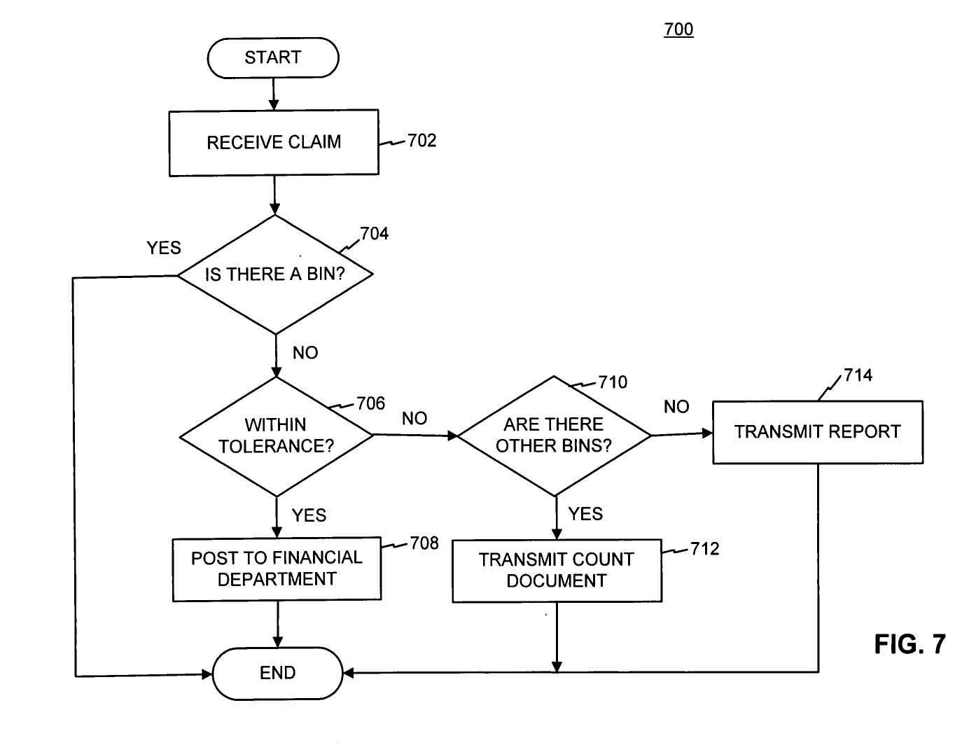

FIG. 7 is a flow diagram 700 of an exemplary method for resolving a no bin situation, consistent with a disclosed embodiment. For example, the method may implement processes according to program modules 518a-518e.

In step 702, receiving and storing module 518a of difference analyzer 216 may receive and store a claim or another discrepancy. The process proceeds to step 704.

In step 704, inventory module 518b may examine the claim or discrepancy from inventory server 210 and evaluate whether a bin exists for that product number and country of origin associated with the stock identified in the claim or discrepancy. If no bins exist in inventory server 210, then the process proceeds to step 706. If bins do exist, then the process ends.

In step 706, analyzing module 518c may determine whether a value and/or quantity of the stock in the claim falls within a tolerance value. If the value and/or quantity of the stock in the claim falls within the tolerance value, then the process proceeds to step 708. If the value and/or quantity of the stock in the claim does not fall within the tolerance value, then the process proceeds to step 710.

In step 708, updating module 518d may automatically post the discrepancy residing in difference analyzer 216 to a financial department and will not update a bin quantity. The process ends.

In step 710, analyzing module 518c determines if there are any other bins for the stock in question, including bins storing the same stock but having a different country of origin. If other bins are identified, then the process proceeds to step 712. If other bins are not identified, then the process proceeds to step 714.

In step 712, transmitter module 518e may transmit a inventory count document to a clerk in order to require a manual recount of the bins. For example, transmitter module 518e may generate and format an appropriate message (such as an e-mail, voice mail, text message, etc.) and transmit that message to another system or one of terminals 220-240 for processing by a clerk. The process then ends.

In step 714, since then there are no other bins in warehouse 105 storing the stock, transmitter module 518e transmits a report, which is used to investigate the discrepancy. For example, a supervisor may later use report later to examine a history of the bins storing the stock in question as a bin no longer exists. The process then ends.

As one of ordinary skill in the art will appreciate, one or more of the above steps in the above processes may be optional and may be omitted from implementations in certain embodiments.

### INDUSTRIAL APPLICABILITY

Systems and methods automatically identify and correct negative bin quantities or no bin situations. For example, a system or method may receive a claim involving stock. A difference analyzer may store a record of the received claim. Furthermore, the system or method may evaluate the claim and determine that there is a negative bin quantity situation or a no bin situation. The system or method may resolve the negative bin quantity situation or the no bin situation.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A system for automatically resolving bin errors, the system comprising:
a difference analyzer that stores a record of a discrepancy involving stock; and
an inventory server comprising a database of inventory records, wherein the inventory server identifies a negative bin quantity or a no bin situation due to the discrepancy, and
when the inventory server identifies a negative bin quantity situation, the inventory server determines whether the negative bin quantity falls within a tolerance value, and
when the inventory server identifies a no bin situation, the inventory server determines whether a bin exists for a product number and a country of origin associated with the stock identified in the discrepancy.

2. The system of claim 1, wherein when the negative bin quantity falls within the tolerance value, the inventory server automatically posts the negative bin quantity to a financial department, and when the negative bin quantity does not fall within the tolerance value, the inventory server automatically transmits an inventory count document to a clerk.

3. The system of claim 1, wherein when the inventory server determines that a bin does not exist for the product number and country of origin, the inventory server determines whether a quantity of the stock identified in the claim falls within a tolerance value.

4. The system of claim 3, wherein if the quantity of the stock falls within the tolerance value, the inventory server automatically posts the quantity to a financial department.

5. The system of claim 4, wherein if the quantity of the stock does not fall within the tolerance value, the inventory server determines whether a bin exists for the product number matching the stock identified in the discrepancy.

6. The system of claim 5, wherein if a bin exists, the inventory server transmits an inventory count document to a clerk, and if a bin does not exist, the inventory server transmits a report to prompt an investigation.

7. A method for automatically resolving bin errors, the method comprising:
receiving a discrepancy involving stock;
storing a record of the discrepancy in a difference analyzer;
identifying a negative bin quantity or a no bin situation due to the discrepancy; and
when a negative bin quantity is identified, determining whether the negative bin quantity falls within a tolerance value, and
when a no bin situation is identified, determining whether a bin exists for a product number and a country of origin matching the stock identified in the discrepancy.

8. The method of claim 7, wherein when the negative bin quantity falls within the tolerance value, the method further comprises:
automatically posting the negative bin quantity to a financial department, and wherein the negative bin quantity does not fall within the tolerance value, the method further comprises:
automatically transmitting an inventory count document to a clerk.

9. The method of claim 7, wherein when a bin does not exist for the product number and country of origin, the method further comprises:
determining whether a quantity of the stock identified in the discrepancy falls within a tolerance value.

10. The method of claim 9, wherein if the quantity of the stock falls within the tolerance value, the method further comprises:
automatically posting the quantity to a financial department.

11. The method of claim 10, wherein if the quantity of the stock does not fall within the tolerance value, the method further comprises:
determining whether a bin exists for the product number matching the stock identified in the discrepancy

12. The method of claim 11, wherein a bin exists, the method further comprises:
transmitting an inventory count document to a clerk, and wherein a bin does not exist, the method further comprises:
transmitting a report prompting an investigation of the discrepancy.

13. A computer-readable medium storing instructions executable by a process for resolving bin errors according to a method, the method comprising:
receiving a discrepancy involving stock;
storing a record of the discrepancy in a difference analyzer;
identifying a negative bin quantity or a no bin situation due to the discrepancy; and
when a negative bin quantity is identified, determining whether the negative bin quantity falls within a tolerance value, and
when a no bin situation is identified, determining whether a bin exists for a product number and a country of origin matching the stock identified in the discrepancy.

14. The computer-readable medium of claim 13, wherein when the negative bin quantity falls within the tolerance value, the method further comprises:
automatically posting the negative bin quantity to a financial department, and wherein the negative bin quantity does not fall within the tolerance value, the method further comprises:
automatically transmitting an inventory count document to a clerk.

15. The computer-readable medium of claim 13, wherein when a bin does not exist for the product number and country of origin, the method further comprises:
determining whether a quantity of the stock identified in the discrepancy falls within a tolerance value.

16. The computer-readable medium of claim 15, wherein if the quantity of the stock falls within the tolerance value, the method further comprises:
automatically posting the quantity to a financial department.

17. The computer-readable medium of claim 16, wherein if the quantity of the stock does not fall within the tolerance value, the method further comprises:
determining whether a bin exists for the product number matching the stock identified in the discrepancy

18. The computer-readable medium of claim 17, wherein a bin exists, the method further comprises:
transmitting an inventory count document to a clerk, and wherein a bin does not exist, the method further comprises:
transmitting a report prompting an investigation of the discrepancy.
